(19) United States
(12) Patent Application Publication
(10) Pub. No.: US 2022/0366305 A1
(43) Pub. Date: Nov. 17, 2022

(54) APPARATUS AND METHODS FOR SENSOR FUSION DATA ANALYTICS USING ARTIFICIAL INTELLIGENCE

(71) Applicant: ZS Associates, Inc., Evanston, IL (US)

(72) Inventors: Gopi Vikranth Bandi, Seattle, WA (US); Prakash, Bengaluru (IN); Arianna Tousi, Seattle, WA (US); Vikas Singhai, New Delhi (IN)

(73) Assignee: ZS Associates, Inc., Evanston, IL (US)

(21) Appl. No.: 17/731,118

(22) Filed: Apr. 27, 2022

Related U.S. Application Data
(60) Provisional application No. 63/180,825, filed on Apr. 28, 2021.

(51) Int. Cl. G06N 20/00

(52) U.S. Cl. CPC G06N 20/00

(57) ABSTRACT

A method can include receiving historical data, sensor fusion data, and customer profile data about a set of customers. The method can include generating a set of customer embeddings, each including a vector representation of an image of a customer in the historical data. The method can include integrating the customer profile data to the set of customer embeddings and identifying a subset of customer images of a subset of sensor fusion data that matches a subset of customer embeddings. The method can include integrating the subset of sensor fusion data to the subset of customer embeddings from which a set of customer behaviors or a set of customer attributes can be identified. The method can include predicting a demand value or a likely path of a customer from the set of customers toward a location based on the set of customer behaviors or the set of customer attributes.

### CROSS REFERENCE TO RELATED APPLICATIONS

This application claims the benefit of and priority to U.S. Provisional Patent Application No. 63/180,825, filed Apr. 28, 2021, which is incorporated herein by reference in its entirety for all purposes.

### TECHNICAL FIELD

The present disclosure relates to the field of artificial intelligence and/or machine learning for sensor fusion data analytics.

### BACKGROUND

Some known data fusion analytics apparatus and methods can be useful in, for example, a retail store. Some known recommendation apparatus and methods, however, do not effectively process customer profile data and sensor fusion data. Thus, a need exists for improved apparatus and methods.

### SUMMARY

In some embodiments, a method can include receiving historical data, sensor fusion data, and customer profile data about a set of customers. The sensor fusion data can include at least one of video data, location data, or beacon data. The customer profile data can include at least one of loyalty data, demographic data, or transaction data. The method can further include generating a set of customer embeddings for the set of customers, each customer embedding from the set of customer embeddings including a vector representation of an image of a customer from the set of customers in the historical data. The method can further include integrating the customer profile data to the set of customer embeddings. The method can further include identifying, after integrating the customer profile data, a subset of customer images of a subset of sensor fusion data among a set of customer images of the sensor fusion data that match a subset of customer embeddings in the set of customer embeddings. The method can further include integrating the subset of sensor fusion data to the subset of customer embeddings. The method can further include identifying, after integrating the subset of sensor fusion data, at least one of a set of customer behaviors or a set of customer attributes based on the subset of customer embeddings. The method can further include predicting at least one of a demand value and a likely path of a customer from the set of customers toward a location based on at least one of the set of customer behaviors or the set of customer attributes.

In another embodiment, a method, comprises receiving, by a processor, historical data, sensor fusion data, and customer profile data associated with a set of customers; creating, by the processor, the received data into a set of customer embeddings for the set of customers, each customer embedding including a vector representation of an image of a respective customer from the set of customers; linking, by the processor, the customer profile data with the set of customer embeddings; identifying, by the processor, a subset of customer images of a subset of sensor fusion data among a set of customer images of the sensor fusion data that match a subset of customer embeddings in the set of customer embeddings; linking, by the processor, the subset of sensor fusion data with the subset of customer embeddings; identifying, by the processor, at least one of a set of customer behaviors or a set of customer attributes based on the subset of customer embeddings; and predicting, by the processor, at least one of a demand value or a likely path of a customer from the set of customers toward a location based on at least one of the set of customer behaviors or the set of customer attributes.

The method may further comprise transmitting, by the processor to an electronic device of at least one customer, a recommendation corresponding to the demand value or the likely path.

The sensor fusion data may comprise at least one of video data, location data, beacon data, audio data, or movement data.

The customer profile data may comprise at least one of loyalty data, demographic data, or transaction data associated with at least a portion of the set of customers.

The processor may extract the set of customer attributes using a customer attribute mapping model that detects data associated with an object associated with at least one customer based on an image of the customer.

The processor may extract the set of customer behaviors using a customer behavior mapping model that detects data associated with at least one of an emotion, a dwell time, gazing, a pace, an instance of moving with a group of at least one customer of the set of customers.

The demand value may correspond to an affinity towards an item.

The processor may execute a machine-learning model to identify the subset of customer images.

The predicting at least one of a demand value or a likely path of a customer from the set of customers toward a location may be further based on customer profile data.

In another embodiment, a computer system comprises one or more processors; and one or more computer-executable instructions that, when executed by the one or more processors, cause the one or more processors to perform operations comprises receiving historical data, sensor fusion data, and customer profile data associated with a set of customers; creating the received data into a set of customer embeddings for the set of customers, each customer embedding including a vector representation of an image of a respective customer from the set of customers; linking the customer profile data with the set of customer embeddings; identifying a subset of customer images of a subset of sensor fusion data among a set of customer images of the sensor fusion data that match a subset of customer embeddings in the set of customer embeddings; linking the subset of sensor fusion data with the subset of customer embeddings; identifying at least one of a set of customer behaviors or a set of customer attributes based on the subset of customer embeddings; and predicting at least one of a demand value or a likely path of a customer from the set of customers toward a location based on at least one of the set of customer behaviors or the set of customer attributes.

The one or more computer-executable instructions may further cause the one or more processors to transmit, to an electronic device of at least one customer, a recommendation corresponding to the demand value or the likely path.

The sensor fusion data may comprise at least one of video data, location data, beacon data, audio data, or movement data.

The customer profile data may comprise at least one of loyalty data, demographic data, or transaction data associated with at least a portion of the set of customers.

The processor may extract the set of customer attributes using a customer attribute mapping model that detects data associated with an object associated with at least one customer based on an image of the customer.

The processor may extract the set of customer behaviors using a customer behavior mapping model that detects data associated with at least one of an emotion, a dwell time, gazing, a pace, an instance of moving with a group of at least one customer of the set of customers.

The demand value may correspond to an affinity towards an item.

The processor may execute a machine-learning model to identify the subset of customer images.

Predicting at least one of a demand value or a likely path of a customer from the set of customers toward a location may be further based on customer profile data.

In another embodiment, a computer system comprises a data repository; and a server having a processor configured to receive historical data, sensor fusion data, and customer profile data associated with a set of customers; create the received data into a set of customer embeddings for the set of customers, each customer embedding including a vector representation of an image of a respective customer from the set of customers; link the customer profile data with the set of customer embeddings; identify a subset of customer images of a subset of sensor fusion data among a set of customer images of the sensor fusion data that match a subset of customer embeddings in the set of customer embeddings; link the subset of sensor fusion data with the subset of customer embeddings; identifying, by the processor, at least one of a set of customer behaviors or a set of customer attributes based on the subset of customer embeddings; and predict at least one of a demand value or a likely path of a customer from the set of customers toward a location based on at least one of the set of customer behaviors or the set of customer attributes.

The processor may further be configured to transmit to an electronic device of at least one customer, a recommendation corresponding to the demand value or the likely path.

### BRIEF DESCRIPTION OF THE DRAWINGS

FIG. 1 is a schematic illustration of a sensor fusion data analytics system, according to an embodiment.

FIG. 2 is a flowchart showing a sensor fusion data analytics method, according to an embodiment.

FIG. 3 is a schematic illustration of a customer embedding, according to an embodiment.

FIG. 4 is a schematic illustration of a data structure for a customer embedding stored in a customer embedding database, according to an embodiment.

FIG. 5 is a schematic illustration of a sensor fusion data analytics device performing a method, according to an embodiment.

### DETAILED DESCRIPTION

Non-limiting examples of various aspects and variations of the embodiments are described herein and illustrated in the accompanying drawings.

Apparatus and methods of sensor fusion data analytics described herein can be used in online marketing campaigns, targeting potential customers with offers in shopping malls/centers, movie theaters, sports stadiums, in-store experience, airports, casinos, metro/train stations, cruises, clinical trials, political campaigns, and the like.

Apparatus and methods of sensor fusion data analytics described herein can process a set of customers' behavioral data such as a behavior(s), an attitude(s), an emotion(s), a historical loyalty, a set of preferences, and/or the like. As a result, the apparatus and methods of sensor fusion data analytics can match behavioral data of a set of customers to inventory in substantially real-time and determine improved/optimal offers for improving/maximizing conversion rate and/or customer elasticity.

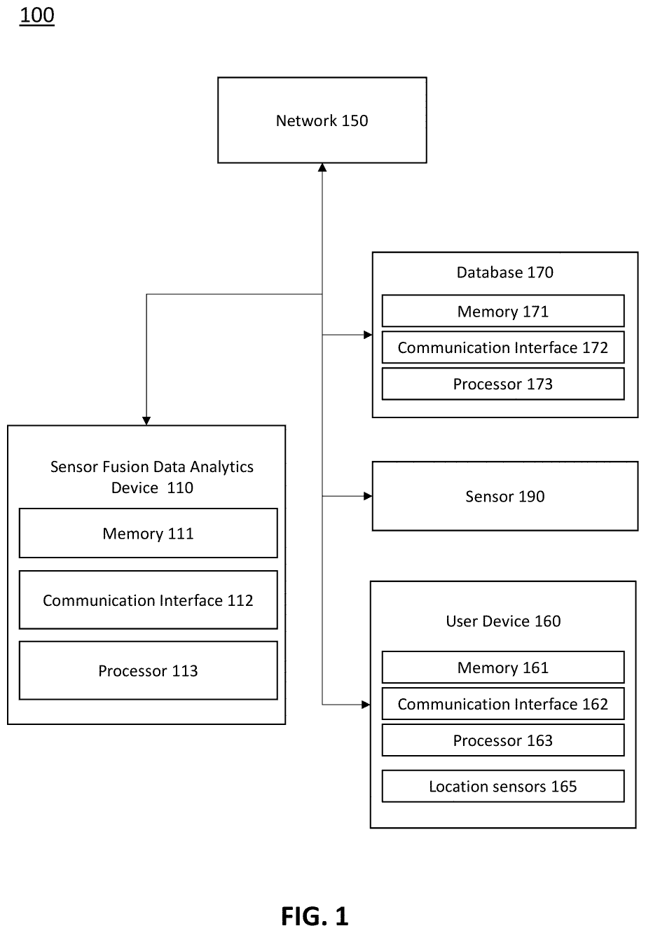

FIG. 1 is a schematic illustration of a sensor fusion data analytics system 100 including sensor fusion data analytics device 110, a network 150, a database 170, a sensor 190 and a user device 160, according to an embodiment. The sensor fusion data analytics system 100 as shown in FIG. 1 can be used to predict a demand value or a likely path of a customer toward a location and recommend an optimal offer for a customer or a segment of customers based on data including, for example, current store offers, inventory data, customer loyalty data, a set of customer behaviors, a set of customer attributes, and/or the like.

The sensor fusion data analytics device 110 (also referred to as ‘the personalized artificial intelligence device’ or ‘the recommendation device’), includes a memory 111, a communication interface 112, and a processor 113 to store, analyze, and communicate data. The sensor fusion data analytics device 110 can be operatively coupled to a user device 160, a sensor 190 (e.g., a video camera(s) at a store), and/or a database 170 via a network 150, to receive and/or transmit data including historical data (e.g., past purchases, past videos, past behaviors, and/or the like), sensor fusion data (e.g., real-time video feed, mobile location data, beacon data, audio data, movement data, and/or the like), and customer profile data (e.g., demographic data, transaction data, loyalty data, and/or the like; also referred to as ‘heterogeneous data’ or ‘customer information’) of a set of customers at a set of locations. The historical data can be defined as data concerning past events. For example, the historical data can be data related to events from an hour ago, two hours ago, a day ago, two days ago, a week ago, two weeks ago, a month ago, two months ago, a year ago, two years ago, and/or the like.

The memory 111 of the sensor fusion data analytics device 110 can be, for example, a memory buffer, a random access memory (RAM), a read-only memory (ROM), a hard drive, a flash drive, a secure digital (SD) memory card, an external hard drive, an erasable programmable read-only memory (EPROM), an embedded multi-time programmable (MTP) memory, an embedded multi-media card (eMMC), a universal flash storage (UFS) device, and/or the like. The memory 111 can store, for example, historical data, sensor fusion data, customer profile data, and one or more software models and/or code that includes instructions to cause the processor 113 to execute one or more processes or functions (e.g., generating a recommendation).

The communication interface 112 of the sensor fusion data analytics device 110 can be a hardware component of the sensor fusion data analytics device 110 to facilitate data communication between the sensor fusion data analytics device 110 and external devices (e.g., the user device 160, the database 170, and/or the senor 190) or internal components of the sensor fusion data analytics device 110 (e.g., the memory 111, the processor 113). The communication interface 112 is operatively coupled to and used by the processor 113 and/or the memory 111. The communication interface 112 can be, for example, a network interface card (NIC), a Wi-Fi® module, a Bluetooth® module, an optical communication module, and/or any other suitable wired and/or wireless communication interface. The communication interface 112 can be configured to connect the sensor fusion data analytics device 110 to the network 150, as described in further detail herein. In some instances, the communication interface 112 can facilitate receiving and/or transmitting data (e.g., historical data, sensor fusion data, customer profile data, and/or the like) via the network 150. More specifically, in some implementations, the communication interface 112 can facilitate receiving and/or transmitting customer profile data (e.g., demographic data) and/or models (e.g., rule-based models and/or machine learning models) through the network 150 from/to the sensor 190, the user device 160 and/or the database 170.

The processor 113 can be, for example, a hardware based integrated circuit (IC) or any other suitable processing device configured to run or execute a set of instructions or a set of codes. For example, the processor 113 can include a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), a graphics processing unit (GPU), a neural network processor (NNP), and/or the like. The processor 113 can be operatively coupled to the memory 111 and/or communication interface 112 through a system bus (for example, address bus, data bus, and/or control bus; not shown).

The database 170 can be/include one or more compute devices particularly suitable for data storage. For example, the database 170 can include a network of electronic memories, a network of magnetic memories, a server(s), a blade server(s), a storage area network(s), a network attached storage(s), deep learning computing servers, deep learning storage servers, and/or the like. The database 170 can include a memory 171, a communication interface 172 and/or a processor 173 that are structurally and/or functionally similar to the memory 111, the communication interface 112, and/or the processor 113 as shown and described with respect to the sensor fusion data analytics device 110. The memory 171 can store the data, the processor 173 can analyze the data (e.g., clean, normalize, process, and/or organize the data), and the communication interface 172 can receive/transmit the data from/to the sensor fusion data analytics device 110, the user device 160, and/or the sensor 190 via the network 150.

The user device 160 is a compute device of a customer of a store, a location, an event, and/or the like. The user device 160 includes a memory 161, a communication interface 162, a processor 163, and a location sensor 165. The memory 161, the communication interface 162, and the processor 163 can be structurally and/or functionally similar to the memory 111, the communication interface 112, and/or the processor 113 as shown and described with respect to the sensor fusion data analytics device 110. The location sensor 163 can be, for example, a global positioning system (GPS) sensor, a gyroscope, and/or the like, and can be configured to measure a location of the user device 160. The user device 160 can be operatively coupled to the sensor fusion data analytics device 110, database 170, and/or the sensor 190 via the network 150.

The sensor 190 can be/include a video camera(s), a temperature sensor(s), a humidity sensor(s), an acoustic sensor(s) (e.g., a microphone), an infrared sensor(s), a touch sensor(s), and/or the like, that records data from an environment in which the senor 190 is located. The sensor 190 can include a memory (not shown) that stores the data recorded by the sensor 190 and a communication interface (not shown; e.g., a transmitter that encrypts and/or compresses a substantially real-time feed data) to transmit/receive data to/from the sensor fusion data analytics device 110, the database 170, and/or the user device 160 via the network 150. In some instances, the sensor 190 can receive a request for a specific type of data (e.g., video feed, acoustic data feed, and/or the like) from the sensor fusion data analytics device 110. In response, the sensor 190 can record the specific type of data (the video feed and the acoustic data feed) in the memory and send the specific type of data to the sensor fusion data analytics device 110 using the communication interface and via the network 150. In some instances, the sensor 190 can be set to automatically collect data (e.g., video feed, infrared image feed, temperature data feed, and/or the like). For example, the sensor 190 can collect data continuously, at a set of predetermined times, at a set of predetermined time intervals, at a dynamically determined time (e.g., triggered by an event), and/or the like.

In use, sensor fusion data analytics device 110 can receive a substantially real-time data feed (e.g., data feed collected from events occurring in the past millisecond, second, 10 seconds, minute, 10 minutes, and/or the like) associated with a set of customers (e.g., registered customers and/or un-registered customers) at a set of locations (e.g., a shopping mall(s), a shopping center(s), a movie theater(s), a stadium(s), a casino(s), an in-store experience(s), an airport(s), an entertainment arena(s), and/or the like). The sensor fusion data analytics device 110 can further capture a set of global positioning system (GPS) data or beacon data (e.g., data collected from wireless transmitters) associated with the user device 160 (e.g., a customer's mobile phone), and integrate and/or associate the set of GPS data or beacon data with the substantially real-time data feed.

The sensor fusion data analytics device 110 can integrate (e.g., concatenate) and store customer profile data that include structured information (e.g., demographic information, transaction information, loyalty information, etc.) and unstructured information (e.g., images, videos, text, and/or the like). The sensor fusion data analytics device 110 can further embed identifiers of the set of customers represented by image vectors to de-identified customer images extracted from video data captured at the set of locations, GPS data, or beacon data, to generate an integrated dataset. The sensor fusion data analytics device 110 can identify a customer image from the image vectors that matches a customer image captured live at the set of locations. In some instances, identification of the customer image, in the image vectors and/or the customer image captured live, can be performed by a machine learning model (e.g., a convolutional neural network model, a residual neural network, and/or the like) trained on labeled data generated based on the historical data (e.g., received from the database 170). In some instances, identification of the customer images can be performed by using one or more pretrained machine learning models such as, for example, a very deep convolutional networks for large-scale image recognition (VGG-16), Inception (also known as ‘GoogLeNet’), ResNet50, EfficientNet, and/or the like. The one or more pretrained machine learning models can be trained further (using transfer learning methods) based on the historical data, the real-time data feed, the user profile data, and/or the like. In some implementations, the trained machine learning model can match an image of a customer received in substantially real-time to a historical image of the customer. This allows the sensor fusion data analytics device 110 to match the customer to a historical profile (e.g., containing demographic information, transaction information, loyalty information, etc.) of the customer in substantially real-time.

The sensor fusion data analytics device 110 can further log and/or store customer level behavior identification (e.g., emotional analysis, store-dwell time identification, pace, path tracking, and/or the like) or customer level attribute identification (e.g., brand preference, wearable, color preferences, and/or the like) based on the video data and the set of locations. The sensor fusion data analytics device 110 can further predict a likely path toward or out of a section of a location from the set of locations based on the video data and the set of locations. The sensor fusion data analytics device 110 can further estimate demand in proximity of a location from the set of locations using sensor fusion data including the video data, customer emotion data analyzed from the video data, the GPS data, and/or the beacon data, collected from the set of customers. The sensor fusion data analytics device 110 can further match customers to inventory assets in substantially real-time and determine an optimal and/or targeted promotion for maximum and/or increased conversion rate and customer elasticity.

Although the sensor fusion data analytics device 110, the database 170, the sensor 190, and the user device 160 are shown and described with respect to FIG. 1 as singular devices, it should be understood that in some embodiments, one or more fusion data analytics devices, one or more databases, one or more sensors, and/or one or more user devices can be used. For example, multiple users within a store can each have a user device used to track and/or provide data associated with that user. For another example, multiple sensors can be used to track users throughout a store.

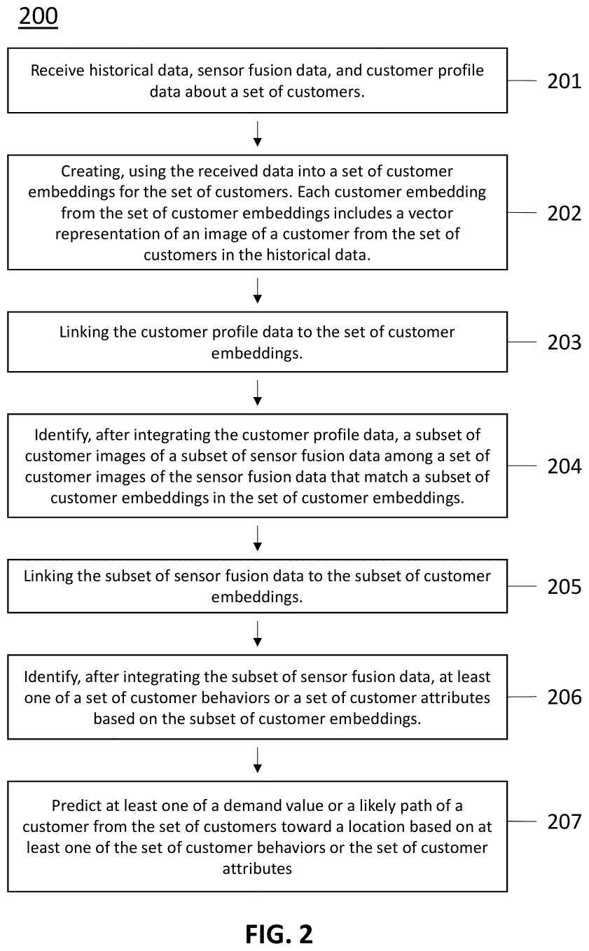

FIG. 2 is a flowchart showing a sensor fusion data analytics method 200, according to an embodiment. In some embodiments, the sensor fusion data analytics method 200 can be performed by a sensor fusion data analytics device (e.g., the sensor fusion data analytics device 110 as shown and described with respect to FIG. 1). The sensor fusion data analytics device can match customer behaviors, attitudes, historical loyalty and preferences to an inventory in substantially real-time (e.g., 500 millisecond, 1 second, 5 seconds, 10 seconds, and/or the like) and determine optimal and/or targeted offers for maximizing and/or improving profit and conversion rate. At 201, historical data, sensor fusion data, and/or customer profile data about a set of customers can be received. The historical data can include past transaction data, past purchases, past videos, past behaviors, past attributes, and/or the like. The sensor fusion data can include a set of videos, global positioning system (GPS) data, beacon data, and/or the like. The customer profile data includes loyalty data, demographic data, transaction data, and/or the like.

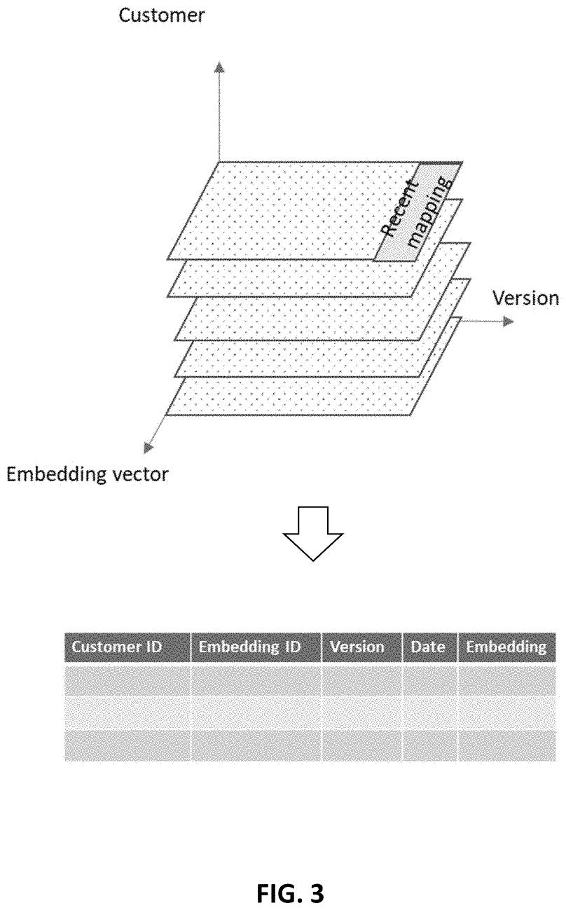

At 202, a set of customer embeddings (e.g., shown in FIG. 3) for a set of customers is generated. The set of customers can be customers for which there is at least one type of data in the historical data. Each customer embedding from the set of customer embeddings can include a vector representation of an image of the customer in the set of historical data. As shown in FIG. 3, the customer embedding can be represented by a three-dimensional variable. For example, the three-dimensional variable can include customer profile data on a first dimension, version (e.g., a time stamp) on a second dimension, and an embedding vector on a third dimension. Generating the customer embedding can involve performing a customer face segmentation (e.g., background-foreground segmentation, near-infrared (near-IR) luminance calculation, skin detection using color, adaptive threshold computation for segmentation of faces, and/or the like). In some instances, the customer embedding can be generated by a machine learning model such as, for example, a convolutional neural network (CNN) based stacked auto-encoder. In some instances, the customer embedding can be used for segmented image normalization using image resolution re-sampling, augmentation, transformation and/or low-pass filters to remove noise.

A human-in-the-loop (HITL) model/approach can be used to validate the customer embedding and produce a validation score. The validation score can be backpropagated to correct or improve the customer embedding. The customer embedding can be stored in a customer embedding database for continuously, sporadically and/or periodically (e.g., once a day, once a week, once a month, at every visit, etc.) updating the customer level data in substantially real-time. The customer embedding database can be used to capture and store various features including an embedding identification, a location, a timestamp, a store name, loyalty information, purchase information, an indication of emotion, an indication of gender, an indication of shop dwell times, a list of shops with time spent and previous purchases (e.g., clothes, shirts, watch, caps, sunglasses, purse/bag, shoes/sandals, jewelry, phone brand and model), wearables used by the customer (e.g., Apple Watch, Fitbit and/or the like), and/or the like. The customer embedding database can involve substantially real-time feed for different use cases such as performing a personalization, an offer optimization, a customer assessment, and/or the like.

In some instances, a customer vector linking model (e.g., executed by processor 113 of the sensor fusion data analytics device 110 of FIG. 1) can be used to integrate (e.g., concatenate) the customer embedding to customer profile data. The customer vector linking model can be used to integrate and/or associate images captured at a set of locations (e.g., malls, airports, movie theaters, sports stadiums, supermarkets and/or the like) with customer profile data (e.g., demographics, loyalty, date of initiation into loyalty program, past purchases, frequency of use or purchase of products and services, number of customer visits, etc.). The customer vector linking model can further generate a set of customer images using information collected from a customer in-store tagged with a customer image. The set of customer images can be stored (e.g., by the customer vector linking model, operating system of the sensor fusion data analytics device 110, and/or the like) in a database (e.g., the customer embedding database). For example, in some instances, the customer can be identified using a video recognition model (e.g., a machine learning model) during and/or after a transaction by matching a substantially real-time image of the customer to the stored set of customer images. The customer embedding database can be used to compare the identified customer to the generated embeddings using a similarity-based metric such as average cosine similarity for customer embeddings collected during a time (e.g., a week, a month, a year, etc.) to produce a similarity value. In some instances, the similarity value can be used to determine integrate and/or map the identified customer to the generated embeddings. The customer vector linking model can be used to integrate customer store-level purchases, brand purchases, location preferences, movie preferences, sport preferences, and/or the like to the customer embedding. The customer embedding can identify a segment of customers with mapped loyalty information and a segment of customers without mapped loyalty information. The customer embedding can involve local personalized information if captured and recorded for customers as unidentified entities. The customer embedding can involve a set of recency filters applied for dataset processing, and therefore can reduce computation by processing recent data and not processing older and/or out-of-date data.

Returning to FIG. 2, at 203, the customer profile data (e.g., demographic data, transaction data, loyalty data, and/or the like) is integrated (e.g., concatenated) to the set of customer embeddings. For example, a loyalty data of a customer can be converted to a string and can then be concatenated to the customer embedding.

At 204, a subset of customer images of a subset of sensor fusion data is identified among a set of customer images of the sensor fusion data that match (at least in part) a subset of customer embeddings in the set of customer embeddings. For example, the set of sensor fusion data can include a set of live video feeds. The live video feeds can be analyzed (e.g., using the sensor fusion data analytics device). For example, frame extraction from the video feeds can be performed to produce the subset of customer images (e.g., that include facial images of a customer(s)) from the set of live video feeds. In some instances, a facial detection and segmentation algorithm can be used to extract a customer image(s) and to perform identification (e.g., using a machine learning model such as, for example, a FaceNet model trained on historical data, a pretrained machine learning model as described with respect to FIG. 1) on the extracted images to produce a first set of identifiers. The first set of identifiers can be compared to a second set of identifiers produced for the set of customer embeddings to identify (e.g., by comparing a distance/similarities between a coordinate value in a knowledge graph) the subset of customer embeddings associated with specific users identified in the images. For example, in some instances, the first set of identifiers and/or the second set of identifiers can be a position in a knowledge graph. Therefore, the subset of customer images can be found to be related to the subset of customer embeddings in the set of customer embeddings.

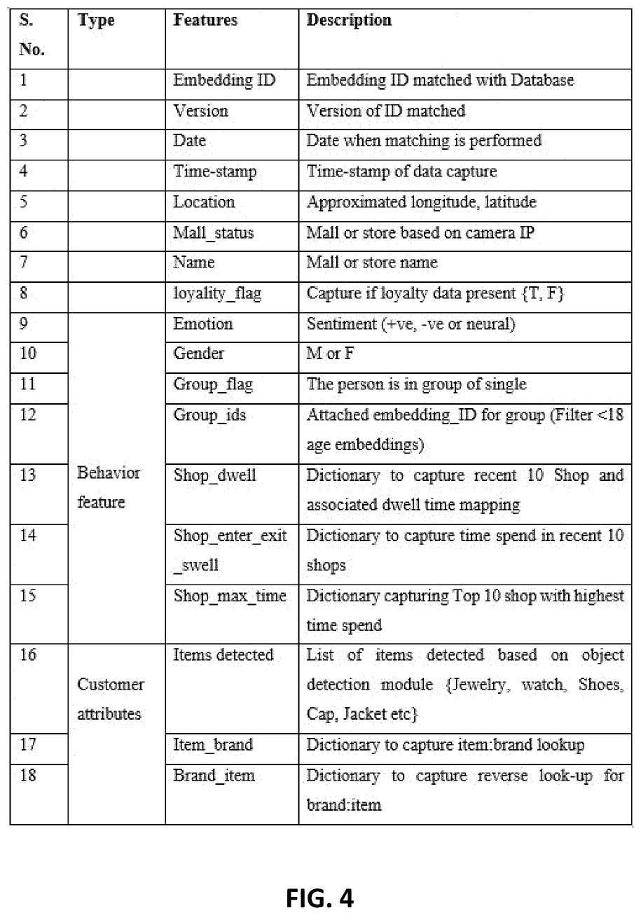

At 205, the subset of sensor fusion data (e.g., video data, image data, location data, and/or the like) can be integrated to the subset of customer embeddings. Each customer embedding from the subset of customer embeddings can have a customer embedding data structure and can be stored in the customer embedding database (e.g., as shown and discussed with respect to FIG. 4). The customer embedding data structure of FIG. 4 can be stored in the customer embedding database (e.g., stored in the memory 171 and/or the memory 111 as shown and described in FIG. 1). Each customer embedding in the customer embedding data structure can be associated with a set of variables such as, for example, a serial number, a data type, a feature, a description, and/or the like. The serial number can be/include any suitable identifier such as, for example, an alphanumerical identifier to uniquely identify the customer associated with that customer embedding. The data type can be/include, for example, a behavior, a customer attribute, and/or the like. The feature can include, for example, an embedding identification (ID), a version, a date, a time-stamp, a location, a mall status, a name (e.g., mall name), a loyalty flag (e.g., a Boolean whether royalty data is available), an indication of emotion, a gender, a group flag (e.g., a Boolean whether a customer is moving in a group), a shop dwell (e.g., a dictionary including recent store visits), a shop dwell time, a shop enter/exit (e.g., capturing time spent in a shop), items detected (e.g., a list of item detected as being viewed by a customer by a camera), item brand (e.g., a list of brands purchased by a customer), and/or the like. The description can be associated with the features and can include a description of the feature. For example, the date feature can be associated with the description “date when matching is performed”.

At 206, a set of customer behaviors or a set of customer attributes can be identified based on the subset of customer embeddings. Identification of the set of customer behaviors and/or the set of customer attributes can be performed using a machine learning model (e.g., a neural network, a decision tree, and/or the like) trained on labeled data generated from the historical data. In some instances, a customer attribute mapping model (e.g., executed by processor 113 of sensor fusion data analytics device 110 of FIG. 1) can be used with a location identification model and a customer behavior mapping model to integrate the set of customer behaviors (e.g., emotion, dwell time and/or the like) and attributes (e.g., brand preferences, color preferences and/or the like) to the customer embedding. For example, the location identification model can collect video feed from a camera (e.g., a closed-circuit television (CCTV)). In some instances, a face segmentation model can be used to process images from the camera and link an image vector to a customer embedding (e.g., a customer embedding ID) and assign a customer location based on an identification of a position of the camera or based on an interaction of a user device (e.g., a cell phone) with a WiFi™ hotspot or a beacon.

Thus, the customer attribute mapping model can be used to extract attributes based on the image using object detection and mapping. The customer attribute mapping model can perform image segmentation using an image feed or a video feed captured by the camera, and further perform object identification from the image (e.g., clothes, shoes, watches, sunglasses, jewelry, etc.) and mapping of objects to brands using a brand images ontology database (e.g., brands such as Gucci, Cole Hann, Cartier, etc.). Moreover, the customer attribute mapping model can be used to map different items with potential brands based on customer preferences (e.g., brand, color, etc.) and purchase power. The customer attribute mapping model can be used to extract following metrics but not limited to brand preferences (e.g., jewelry, shirt and brand, shoes and brand, purse and brand, shop and brand went to in recent purchase, etc.), wearables (e.g., Apple Watch, Fitbit and other wearable tech products) and color or style preferences (e.g., a particular pattern of shirt, leather straps in wrist watches, sneakers over loafers and/or the like) to add to the customer embedding database.

In some instances, a customer behavior mapping model can be used to capture metrics (e.g., an emotion, a dwell time, gazing, a pace, an instance of moving with a group, and/or the like) associated with a customer behavior(s) based on a video feed (e.g., captured by a camera). The customer behavior mapping model can analyze a substantially real-time data feed of the customer to produce behavioral information and integrate (e.g., concatenate, link, etc.) the customer embedding with the behavioral information using a similarity-based search by applying a constraint on the defined metric (e.g., a lower limit constraint can be applied on a cosine similarity metric, an upper limit constraint can be applied for a distance based metric such as Euclidian distance, and/or the like). The constraints can be defined using a distribution from an observed similarity score for a customer using that customer's prior set of embeddings for a defined confidence value such as, for example, 95%. For customers with a limited amount of historical data, a global threshold value can be used to define the constraint for the defined metric. In some instances, if a customer embedding is not available and/or is not identified based on the substantially real-time data feed, a new customer embedding can be generated with the behavioral information. The customer behavior mapping model can be used to identify different aspects of customer behaviors including emotion (e.g., happy, sad, relaxed, in a hurry, wandering, looking for something specific, etc.) based on face segmentation and analysis, store gazing based on where the customer is gazing and associated dwell time, and/or the like.

In one example, a customer is in a store that sells football merchandise and looks at a jersey for more than a specific time period (e.g., more than 15 seconds) or a customer is gazing at jewelry for a longer than average period of time (e.g., more than 2 minutes) within a jewelry store indicating an attraction of the customer to the jersey or the jewelry. In another example, customers visiting a store alone or in a smaller group or if a customer is traveling with kids have a likelihood of a potential purchase that is higher than average. Information extracted from the customer behavior mapping model can be integrated with the customer location and timestamped to extract customer time and pace toward a brand store (e.g., mood, emotion, being in a hurry, interests, needs, preferences, purpose, and/or the like). Customers pacing towards a brand store or shop can be indicative of having a specific purpose and product in mind. The customer behavior mapping model can also capture gender information and/or age information to segment customers. For example, a customer traveling with kids, reacting with joy when looking at various toys and dwelling for a long time period at toy stores could be a potential customer for toys and/or other children's products. In some instances, information captured by models and/or the customer embedding can be compressed for substantially real-time feed transmission (e.g., a faster transmission of video from the camera to the sensor fusion data analytics device).

Returning to FIG. 2, at 207, at least one of a demand value or a likely path of a customer from the set of customers toward a location can be predicted based on at least the set of customer behaviors or the set of customer attributes. The set of customer behaviors and/or the set of customer attributes can be matched with a store inventory and a set of store offers and recommended personalized item-offer recommendations can be transmitted on a screen(s). For example, the personalized item-offer recommendations can be transmitted to and displayed on a smart phone screen for registered customers (e.g., using contact information in the customer profile data that integrated and/or linked to the set of customer embeddings) and/or displayed on a display screen of a store using general segment-based personalization for un-registered customers (as well as registered customers) using video data, location data, beacon data, and/or the like captured by a sensor(s) (e.g., as shown and described with respect to FIG. 1). In one example, a promotion/recommendation can be displayed on a display screen of a bookstore based on a path of an unregistered customer as the unregistered customer approaches the bookstore. In another example, a promotion/recommendation can be displayed on a smartphone screen of a registered customer as the registered customer approaches the bookstore.

In one example, substantially real-time data can be analyzed based on the substantially real-time feed (e.g., video data, sound data, and/or the like) of a customer and recorded information about the customer (e.g., loyalty information), to recommend items in-store. In some instances, the sensor fusion data analytics device (e.g., the sensor fusion data analytics device 110 shown and described in FIG. 1) can push and/or send (e.g., via the network 150 shown and described in FIG. 1) a personalized offer and/or promotion (e.g., to maximize and/or improve conversion rate and customer elasticity) using a personalized display connector model (e.g., executed by the sensor fusion data analytics device 110 of FIG. 1). In some instances, the personalized offer and/or promotion can be dynamically optimized and/or improved based on localized distribution changes. For example, the personalized offer and/or promotion can be optimized based on an inventory about which a detailed and substantially live count of available items is made available to the sensor fusion data analytics device.

In one example, substantially real-time captured data about a set of customers in an electronic store can be analyzed such that demand for each item in the inventory of the electronic store and a most-optimal and/or a potentially effective offer can be displayed to the set of customers on a graphical user interface of cell phones of the set customers and/or on a screen of a store. For example, a customer alone and/or in a group entering a mall in which the electronic store is located can be analyzed based on time spent in front of other stores in the mall while also monitoring emotion and pace of the set of customers to determine/predict a demand for an item in the electronic store before the set of customers reach the electronic store. Therefore, the demand value is a numerical score/likelihood of the demand associated with a particular store. For instance, the demand value indicate a likelihood that the user has an affinity towards going to a particular location (e.g., store) and/or buying a particular item. A variety of offers can be generated for the set of customers and displayed on graphical user interfaces of cell phones of the set of customers, on a set of screens of the mall, and/or the like, to increase a revenue of the electronic store and/or the mall.

The behavior mapping model and a customer segmentation model (e.g., executed by the sensor fusion data analytics device 110 of FIG. 1) can map a customer preference to a store (e.g., a store inventory) using a first segmentation method that uses substantially real-time data and/or a second segmentation method that uses previously recorded or stored data. The first segmentation method can involve capturing in substantially real-time, the customer preferences, for example, inferred from the set of customer behaviors, and/or based on brand or items purchased or wearables (e.g., capturing customer dwell time, brand preferences in real-time) to generate an effective and/or personalized offer. The second segmentation method can use previously recorded or stored data such as, for example, customer loyalty data, past purchase information, and/or the like, to determine prior preferences and/or tendencies and leverage such prior preferences and/or tendencies to generate offers (e.g., a customer who has purchased luxury watches in the past can be a potential customer for a luxury watch brand or a customer with a past purchase of running shoes can be a potential customer for a sports shoe brand based on purchase power).

The customer store eligibility model can be used to predict a likely path that a customer will take to a store (e.g., a store in a mall, a food court in a movie theater, a book-store at an airport, and/or the like) and/or a likelihood of a customer entering the store (e.g., entering a particular store in a mall, entering a food court in the movie theater, a book-store at the airport, and/or the like). The customer store eligibility model can involve using previously stored preferences or transactional level data with substantially real-time preferences and group information to predict the likely path that the customer would take to the store and/or the likelihood of the customer entering the store. The customer store eligibility model can be used to map customers to stores with high likelihood to enter (e.g., 70%, 80%, 90%, 99%, etc. chance to enter) and/or screens with a high likelihood to pass by (e.g., 70%, 80%, 90%, 99%, etc. chance to pass by).

In some embodiments, the sensor fusion data analytics device (e.g., the sensor fusion data analytics device 110 as shown and described with respect to FIG. 1) can be used to combine store information including offer, inventory offers and loyalty program information with an optimization model (e.g., executed by the sensor fusion data analytics device 110 of FIG. 1) that has objective function for maximizing and/or increasing revenue or profit. In some instances, the optimization model can be performed as offer projected versus conversion (sales). For example, a customer (registered or un-registered) defined in a diameter d likelihood to purchase an i^{th} item from store s for which the optimization model is performed can be represented by Pr(item=i|X). In some instances, for example, the optimization model can be performed by maximizing and/or increasing revenue (or profit across customer in defined radius) and the objective function can be defined as in Eq. (1) where Pr(item=j|i) is probability of cross-sell of list of items when i is purchased and X is attributes associated with customers.

max(Σ_{c}Pr(item=i|X)*costᵢ+Pr(item=j|i)) (1)

An optimal and/or suggested item offer calculated by Eq. (1) can be pushed and/or sent to a display (e.g., a display in a store, a display on a screen of a smart phone of a customer, etc.), via an application programming interface (API), at a mall, an airport, a sports arena, and/or the like. The items on display are re-evaluated in defined batch-time to ensure the displayed offer or advertisement is still optimal and/or targeted. The optimization model can be performed across stores simultaneously where offers and/or information can be pushed and/or sent to displays based on inventory and/or customer preferences and can be extended for other substantially real-time operations including but not limited to an offer optimization, a customer assessment, a store assessment, and/or the like. For example, an optimal item offer generated by the optimization model can be a brand of jewelry that the customer may have spent time gazing at in a mall, a jersey of the soccer team of the customer's choice, a book from the airport book store based on genre of preference, and/or the like.

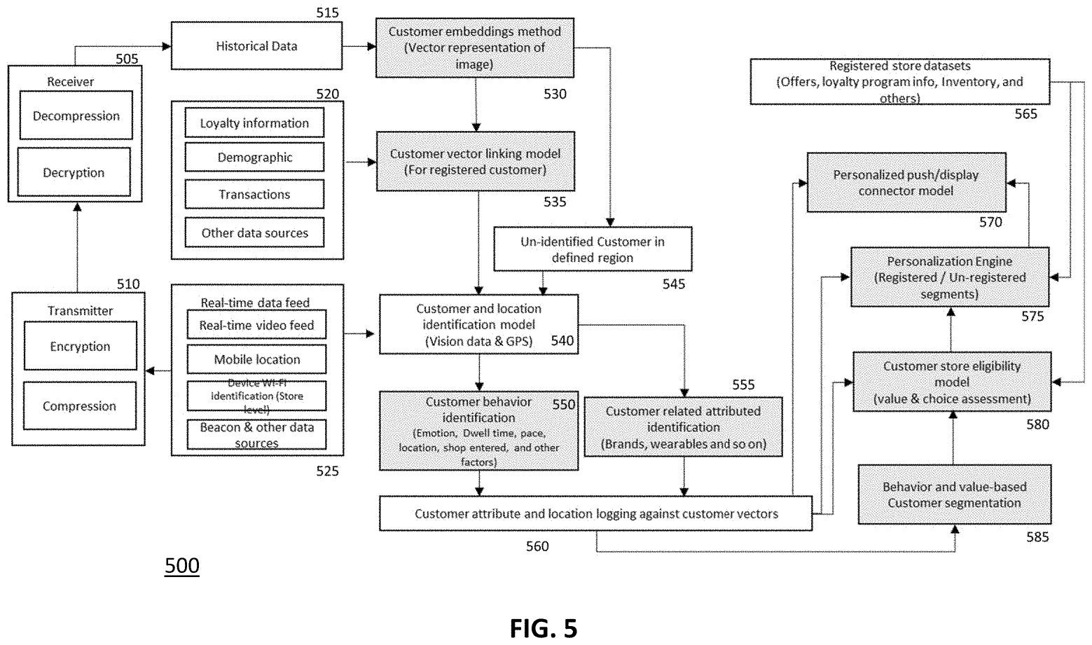

FIG. 5 is a schematic illustration of a sensor fusion data analytics system 500 (e.g., implemented on the sensor fusion data analytics system 100 shown and described with respect to FIG. 1) performing a method, according to an embodiment. The sensor fusion data analytics system 500 can have and/or gain access to historical data associated with a set of customers of a store, a movie theater, an event, a department store, and/or the like. The sensor fusion data analytics system 500 can also have and/or gain access to customer profile data associated with the set of customers. The set of user profile data can include loyalty information, demographic data, transaction data, and/or the like. The sensor fusion data analytics system 500 can also collect substantially real-time data 525 such as, for example, substantially real-time image/video feed data, mobile location data, device WiFi™ data (e.g., for identifying a floor level of a store and/or identifying the store), beacon data, and/or the like collected by at least one sensor device (e.g., the sensor 190 as shown and described with respect to FIG. 1).

The substantially real-time data feed 525 can be transmitted using a transmitter 510. The transmitter 510 can have an encryption engine and a compression engine that can collectively prepare and transmit the real-time data feed securely and efficiently. The sensor fusion data analytics system 500 can store (e.g., in one or more memories of device within the sensor fusion data analytics system) a variety of structured and/or semi structured data collected from a variety of sources and at a variety of times. In one example, the transmitter 510 is part of the sensor 190 as shown and described with respect to FIG. 1 and transmits encrypted and compressed data produced by the transmitter 510 to, for example, the sensor fusion data analytics device 110 and/or the data server 170 shown and described in FIG. 1. The sensor fusion data analytics device 110 can include a receiver 505 (also referred to as the ‘communication interface 112’ shown and described with respect to FIG. 1) that decompresses and decrypts the encrypted and compressed data. The decompressed and decrypted data can be stored as historical data.

A customer embedding model 530 can be used to generate customer embeddings for customers based on the historical data. Each customer embedding can include a vector representation of an image of a customer in the historical data. The customers can include registered customers (that have user profiles) and unregistered customers (that do not have user profiles). A customer vector linking model 535 can be used to associate the customer embeddings to user profile data 520. The unregistered customers can be associated to region and/or locations 545 for which previous data was recorded. The real-time data feed 525 and/or the user profile data 520 can be integrated (e.g., concatenated) to the customer embeddings depending on availability of such data.

A customer behavior identification model 550 and a customer attribution identification model 555 can be used to identify behaviors (e.g., emotion, dwell time, pace, and/or the like) and attributes (e.g., brand affinity, wearables, and/or the like) for the customers based on the customer embeddings. The behaviors and the attributes identified by the customer behavior identification model 550 and the customer attribution identification model 555 can be used, at 560, to log and/or store customer behaviors, attributes, and location against customer vectors. Thereafter, the customer behaviors and attributes can be used to segment, at 585, the customers. For example, a subset of customers can be segmented for a diet burger promotion based on a long dwelling time in front of a fast-food restaurant and/or a health record. Furthermore, a customer store eligibility model 580, a personalization engine 575, and a personalized push/display connector model 570 can use the customer behaviors and attributes to perform value and choice assessment, registered/unregistered segmentation, and/or promotion display to a customer, respectively. In some instances, a set of registered store data sets (e.g., loyalty program information, inventory, and/or the like) can be used by the customer store eligibility model 580, the personalization engine 575, and the personalized push/display connector model 570 to dynamically optimize and/or improve the personalized offers and/or promotions based on localized distribution changes as described in further detail with respect to FIG. 2.

In a non-limiting example, a method may include a computer enabled system comprising of a data repository store, customer image vectors and real-time (or near real-time) customer attributes and behaviors based on raw interaction data of a set of customers. The method may further includes systems to receive real-time data feed of registered and un-registered customers at various locations including but not limited to shopping malls/centers, movie theaters, sports stadiums, casinos, in-store experiences, airports and entertainment arenas. The method may also include systems to capture and integrate location data (e.g., mobile GPS and Beacon data). The method may also include systems to merge and store heterogeneous data source including structured information such as demographics and unstructured information comprising of image, video and text. The method may also include systems to integrate registered customer behavior with store inventory and offers and push recommended hyper-personalized item-offer recommendation on screens for registered customers and general segment-based personalization for un-registered customers using localized information captured using video, location and beacon data. The method may also include systems to embed customers as image vectors to de-identified customer image extracted from video and integrated with location.

The method may also include systems to integrate demographic, transaction, loyalty and other customer related data sources with image vector using images captured at POS (e.g., malls/centers, movie theaters, sports stadiums, airports, etc.). The method may also include systems to compress and store integrated dataset for both registered and un-registered customers merged with compressed and encrypted heterogeneous data sources for real-time feed transmission. The method may also include systems for near real-time customer identification and matching to customer image vector and location using image captured from CCTV cameras at various locations including but not limited to malls, movie theaters, sports arenas and the like. The method may also include systems for logging customer level behavior identification including but not limited to emotional analysis, store-dwell time identification, pace, path tracking using video and location. The method may also include systems for logging customer level attribute identification including but not limited to brands preferences, wearables, color preferences. The method may also include systems for likelihood path prediction toward a store moving to certain sections and or exiting large spaces using video and location. The method may also include systems for real-time estimation of demand in proximity (e.g., store) using sensor fusion: video data, customer emotions from video, Wi-Fi and other sensors, location data from phone and in-app. The method may also include systems for segmentation of customers based on emotion, movement, value, location to generate segmented localization personalization.

The method may also include systems for matching customers to inventory assets real-time and determine the optimal promotion for maximum conversion rate and customer elasticity. The method may also include systems for identifying best channel for both registered and un-registered customers based on customer behavioral and physical attributes. The method may also include systems for promotion at personalization or segment level depending on customer preference and data available through but not limited to digital displays, mobile, email, text, app, fixed displays or third-party APIs. The method may also include systems for optimizing and testing of day level promotion using localized information including but not limited to video and location with structured data including but not limited to transaction, loyalty, store inventory. The method may also include systems for dynamic promotion optimization based on localized distribution changes.

It should be understood that the disclosed embodiments are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. Thus, it is to be understood that other embodiments can be utilized, and functional, logical, operational, organizational, structural and/or topological modifications may be made without departing from the scope of the disclosure. As such, all examples and/or embodiments are deemed to be non-limiting throughout this disclosure.

Some embodiments described herein relate to methods. It should be understood that such methods can be computer implemented methods (e.g., instructions stored in memory and executed on processors). Where methods described above indicate certain events occurring in certain order, the ordering of certain events can be modified. Additionally, certain of the events can be performed repeatedly, concurrently in a parallel process when possible, as well as performed sequentially as described above. Furthermore, certain embodiments can omit one or more described events.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and software development tools. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

In order to address various issues and advance the art, the entirety of this application (including the Cover Page, Title, Headings, Background, Summary, Brief Description of the Drawings, Detailed Description, Claims, Abstract, Figures, Appendices, and otherwise) shows, by way of illustration, various embodiments in which the claimed innovations can be practiced. The advantages and features of the application are of a representative sample of embodiments only and are not exhaustive and/or exclusive. They are presented to assist in understanding and teach the claimed principles.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features.

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of.” “Consisting essentially of,” when used in the embodiments, shall have its ordinary meaning as used in the field of patent law.

What is claimed is:

1. A method, comprising:
receiving, by a processor, historical data, sensor fusion data, and customer profile data associated with a set of customers;
creating, by the processor using the received data, a set of customer embeddings for the set of customers, each customer embedding including a vector representation of an image of a respective customer from the set of customers;
linking, by the processor, the customer profile data with the set of customer embeddings;
identifying, by the processor, a subset of customer images of a subset of sensor fusion data among a set of customer images of the sensor fusion data that match a subset of customer embeddings in the set of customer embeddings;
linking, by the processor, the subset of sensor fusion data with the subset of customer embeddings;
identifying, by the processor, at least one of a set of customer behaviors or a set of customer attributes based on the subset of customer embeddings; and
predicting, by the processor, at least one of a demand value or a likely path of a customer from the set of customers toward a location based on at least one of the set of customer behaviors or the set of customer attributes.

2. The method of claim 1, further comprising:
transmitting, by the processor to an electronic device of at least one customer, a recommendation corresponding to the demand value or the likely path.

3. The method of claim 1, wherein the sensor fusion data comprises at least one of video data, location data, beacon data, audio data, or movement data.

4. The method of claim 1, wherein the customer profile data comprises at least one of loyalty data, demographic data, or transaction data associated with at least a portion of the set of customers.

5. The method of claim 1, wherein the processor extracts the set of customer attributes using a customer attribute mapping model that detects data associated with an object associated with at least one customer based on an image of the customer.

6. The method of claim 1, wherein the processor extracts the set of customer behaviors using a customer behavior mapping model that detects data associated with at least one of an emotion, a dwell time, gazing, a pace, an instance of moving with a group of at least one customer of the set of customers.

7. The method of claim 1, wherein the demand value corresponds to an affinity towards an item.

8. The method of claim 1, wherein the processor executes a machine-learning model to identify the subset of customer images.

9. The method of claim 1, wherein predicting at least one of a demand value or a likely path of a customer from the set of customers toward a location is further based on customer profile data.

10. A computer system comprising:
one or more processors; and
one or more computer-executable instructions that, when executed by the one or more processors, cause the one or more processors to perform operations comprising:
receiving historical data, sensor fusion data, and customer profile data associated with a set of customers;
creating, using the received data, a set of customer embeddings for the set of customers, each customer embedding including a vector representation of an image of a respective customer from the set of customers;
linking the customer profile data with the set of customer embeddings;
identifying a subset of customer images of a subset of sensor fusion data among a set of customer images of the sensor fusion data that match a subset of customer embeddings in the set of customer embeddings;
linking the subset of sensor fusion data with the subset of customer embeddings;
identifying at least one of a set of customer behaviors or a set of customer attributes based on the subset of customer embeddings; and
predicting at least one of a demand value or a likely path of a customer from the set of customers toward a location based on at least one of the set of customer behaviors or the set of customer attributes.

11. The system of claim 10, wherein one or more computer-executable instructions further cause the one or more processors to transmit, to an electronic device of at least one customer, a recommendation corresponding to the demand value or the likely path.

12. The system of claim 10, wherein the sensor fusion data comprises at least one of video data, location data, beacon data, audio data, or movement data.

13. The system of claim 10, wherein the customer profile data comprises at least one of loyalty data, demographic data, or transaction data associated with at least a portion of the set of customers.

14. The system of claim 10, wherein the processor extracts the set of customer attributes using a customer attribute mapping model that detects data associated with an object associated with at least one customer based on an image of the customer.

15. The system of claim 10, wherein the processor extracts the set of customer behaviors using a customer behavior mapping model that detects data associated with at least one of an emotion, a dwell time, gazing, a pace, an instance of moving with a group of at least one customer of the set of customers.

16. The system of claim 10, wherein the demand value corresponds to an affinity towards an item.

17. The system of claim 10, wherein the processor executes a machine-learning model to identify the subset of customer images.

18. The system of claim 10, wherein predicting at least one of a demand value or a likely path of a customer from the set of customers toward a location is further based on customer profile data.

19. A computer system comprising:
a data repository; and
a server having a processor configured to:
receive historical data, sensor fusion data, and customer profile data associated with a set of customers;
create, using the received data, a set of customer embeddings for the set of customers, each customer embedding including a vector representation of an image of a respective customer from the set of customers;
link the customer profile data with the set of customer embeddings;
identify a subset of customer images of a subset of sensor fusion data among a set of customer images of the sensor fusion data that match a subset of customer embeddings in the set of customer embeddings;
link the subset of sensor fusion data with the subset of customer embeddings;
identifying, by the processor, at least one of a set of customer behaviors or a set of customer attributes based on the subset of customer embeddings; and
predict at least one of a demand value or a likely path of a customer from the set of customers toward a location based on at least one of the set of customer behaviors or the set of customer attributes.

20. The system of claim 19, wherein the processor is further configured to:
transmit to an electronic device of at least one customer, a recommendation corresponding to the demand value or the likely path.
